(19) United States
(12) Patent Application Publication
(10) Pub. No.: US 2009/0219916 A1
(43) Pub. Date: Sep. 3, 2009

(54) METHOD TO SCAN FOR CRITICAL TRANSMISSIONS WHILE TRANSMITTING ON A CONVENTIONAL TIME DIVISION MULTIPLE ACCESS CHANNEL

(75) Inventor: THOMAS BOHN, MCHENRY, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/040,442

(22) Filed: Feb. 29, 2008

(51) Int. Cl. H04B 7/212

(52) U.S. Cl. 370/347

(57) ABSTRACT

A method allowing wireless communications devices to scan for critical transmissions while transmitting on a conventional time division multiple access channel (TDMA) is disclosed. The TDMA channel is divided into a plurality of slots, each slot capable of carrying audio, video, control, and/or data transmissions. A first slot is used by a first communication device, while a second slot is used by a second communication device. The first communication device transmits at least one burst of information from a first transmission in a first slot. The first communication device switches to a second slot and reads at least one signaling information segment embedded in a second transmission that is being transmitted in the second slot. The first communication device determines to terminate the first transmission in order to receive the second transmission, or to switch back to the first slot and repeat the steps of transmitting, switching, reading and determining.

### FIELD OF THE DISCLOSURE

This disclosure relates generally to communication systems, and more particularly, to a method to allow communication devices to scan for critical transmissions while transmitting on a conventional time division multiple access (TDMA) channel.

### BACKGROUND OF THE DISCLOSURE

Public organizations such as first responders, as well as other organizations, often rely on conventional two-way, wireless mobile and portable radios to convey voice and data in an efficient, reliable manner. Often these conventional communication systems have no centralized controlling infrastructure, only dispatch consoles or base stations. The communication devices wirelessly communicate with each other and the base sites, typically using frequency division multiple access (FDMA) technology with half-duplex communication devices.

When a communication device begins a transmission on a conventional channel, the transmission occurs on a preprogrammed channel. The communication device transmits on the preprogrammed channel until the communication device is dekeyed. Using FDMA technology, however, when communication devices operate in half-duplex mode, the communication device is typically not capable of receiving any signals or commands from a base station or another communication device while it is transmitting.

Consequently, if a communication device is transmitting while a critical transmission is being broadcast of which the communication device should be aware, the communication device misses the critical transmission. In order to scan for critical transmissions, the communication device needs to dekey which would otherwise adversely affect the quality of its own transmission. As features, such as Automatic Vehicle Location (AVL), are introduced that require frequent transmissions, there is a greater likelihood of missing the critical transmission. Moreover, missing the critical transmission also becomes concerning when there is a need to respond quickly.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 illustrates an exemplary block diagram of a wireless communication system that may be used for implementing the present disclosure;

FIG. 2 illustrates a flow chart for a communication device to periodically scan for critical transmissions in an alternate slot of a conventional TDMA channel while transmitting in its own slot on the TDMA channel in accordance with the present disclosure; and

FIG. 3 illustrates a block diagram of an embodiment of an embedded link control signal in a conventional TDMA channel in accordance with the present disclosure.

Skilled artisans will appreciate that elements in the figures are illustrated for simplicity and clarity and have not necessarily been drawn to scale. Also, common, but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will be understood that the terms and expressions are used with respect to their corresponding respective areas of inquiry and study except where specific meaning have otherwise been set forth herein.

### DETAILED DESCRIPTION OF THE DISCLOSURE

A method allowing a wireless communications device operating in a half-duplex mode to periodically scan for critical transmissions in an alternate slot of a conventional TDMA channel while transmitting in its own slot on the channel is disclosed. In accordance with the present disclosure, a communication device may be provisioned to consider a transmission to be a “critical transmission” if it is an emergency transmission, a transmission that has a high priority, a transmission that has a higher priority than its own transmission, a transmission from a particular communication device (e.g., a supervisor), and/or the like. Each communication device is configured to operate in half-duplex mode, in which each communication device is capable of either transmitting or receiving at a given instant. A wireless communication device transmits a transmission using TDMA technology on a conventional channel which is divided into slots. In the present disclosure, the channel is divided into at least two slots, a first slot and a second slot, each capable of carrying audio, video, control, and/or data transmissions. A first slot is used by a first communication device while a second slot is used by a second communication device. While the first communication device is transmitting a first transmission in the first slot of the TDMA channel, the second communication device is transmitting a second transmission in the second slot of the TDMA channel. While the first communication device is transmitting the first transmission, it also periodically scans the second slot for signaling information segments embedded in the second transmission being transmitted by the second communication device in the second slot of the TDMA channel. Once the first communication device reads all of the embedded signaling information segments from the second transmission, that are needed to form a link control message, the first communication device determines whether to terminate its own transmission being transmitted in the first slot in order to receive the second transmission being transmitted in the second slot by the second communication device, or whether to ignore the second transmission being transmitted in the second slot by the second communication device and continue transmitting its own transmission in the first slot. It is important to note that the communication device makes the decision to terminate its own transmission being transmitted in the first slot in order to receive the second transmission being transmitted in the second slot, or to ignore the second transmission being transmitted in the second slot and continue transmitting its own transmission in the first slot is made independently (i.e., the first communication device does not receive direction or instructions from the second communication device, the base station/radio, or any other device in the wireless communication system) based on the embedded signaling information segments and/or link control message read from the second transmission, for example, the status of the emergency and priority bits in the service options field of the link control information embedded throughout the second transmission.

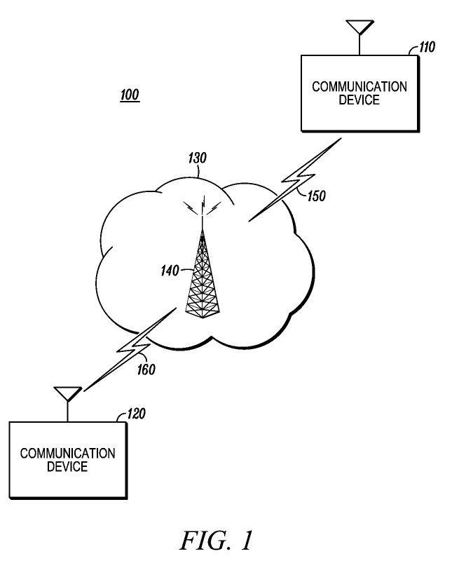

Let us now refer to the figures to describe the present disclosure in greater detail. FIG. 1 illustrates an exemplary block diagram of a wireless communication system 100 that may be used for implementing the present disclosure. Wireless communication system 100 comprises communication devices 110 and 120, which may, for example, be a mobile or portable radio, a cellular radio and/or telephone, a video terminal, a portable computer with a wireless modem, a personal digital assistant, or any other type of wireless communication device. It should be noted that the communication devices 110 and 120 are also referred to in the art as mobile stations, mobile equipment, handsets, subscribers, or the like.

In this exemplary embodiment, communication devices 110 and 120 communicate over a communication access network 130. Of course, those of ordinary skill in the art will realize that any type of network is within the scope of the teachings herein. Thus, the communication access network 130 may comprise infrastructure devices, such as, but not limited to, base stations (with a single base station 140 shown for clarity) to facilitate the communications between the communication devices 110 and 120 having access to the communication access network 130.

For example, communication device 110 and communication device 120 may communicate with each other by communication device 110 establishing a wireless link or radio connection 150 with the base station 140 over an available radio frequency (RF) channel, and communication device 120 establishing a wireless link 160 with the base station 140 over an available RF channel. As is well understood in the art, the base station 140 generally comprises one or more repeaters that can receive a signal from communication device 110 over link 150 and retransmit the signal to communication device 120 over link 160, or can receive a signal from communication device 120 over link 160 and retransmit the signal to communication device 110 over link 150. For ease of illustration, only two communication devices 110, 120 and one base station 140 are shown. Those skilled in the art, however, will realize that in a typical system, a much larger number of communication devices are supported by the communication access network, which has many more base stations than is shown in FIG. 1. Moreover, although in this embodiment, communications between communication devices 110 and 120 are illustrated as being facilitated by the base station 140, communication devices 110 and 120 may communicate using a direct mode of operation without the base station. The teachings herein are equally applicable to direct mode operation between the two communication devices 110 and 120.

Since the communication access network 130 is a wireless network, meaning that it supports a wireless or air interface protocol for signal transmission, both of the communication devices 110 and 120, and the base station 140 comprise a transmitter and a receiver (or a transceiver) for transmitting and receiving RF signals, respectively. Communication devices 110 and 120, and the base station 140 further comprise one or more processing devices (such as, a microprocessor, a digital signal processor, a customized processor, a field programmable gate array (FPGA), unique stored program instructions (including both software and firmware), state machines, etc.) and typically some type of conventional memory element for performing (among other functionality) the air interface protocol and channel access scheme supported by network 130. Using these protocols, communication devices 110 and 120 generate RF signals containing one or more transmissions comprising a plurality of fields for organizing the continuous bits of information and/or signaling for transmission to another communication device.

Of course, while one embodiment of the wireless communication system 100 is described with regards to FIG. 1, those skilled in the art will recognize and appreciate that the specifics of this illustrative example are not specifics of the disclosure itself and that the teachings set forth herein are applicable in a variety of alternative settings. For example, while one embodiment is in compliance with the European Telecommunications Standards Institute (ETSI) Technical Specification (TS) for Digital Mobile Radios (DMR), other embodiments compatible with the present disclosure are contemplated. Further, while the air interface protocol for a DMR using a TDMA channel access scheme is defined in ETSI TS 102 361-1, the present disclosure is compatible with other protocols utilizing a TDMA-type air interface.

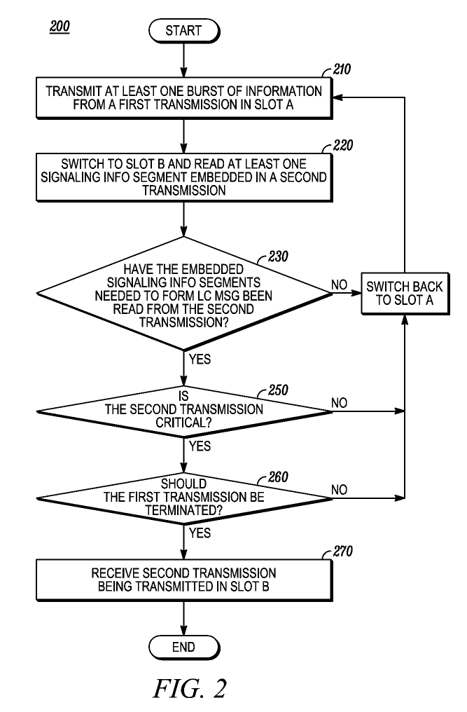

Referring now to FIG. 2, a flow chart 200 exemplifying the present disclosure for periodically scanning for critical transmissions in an alternate slot of a conventional TDMA channel while transmitting in its own slot on the TDMA channel is shown. In accordance with the present disclosure, a communication device 110 transmits a burst of information from a first transmission (e.g., audio, video, control, and/or data transmission) in slot A of a two-slot TDMA channel having a slot A and a slot B at step 210. As well understood in the art, a transmission comprises at least one burst of information. While the present disclosure uses a two-slot TDMA channel, it is to be understood that the present disclosure can also be utilized on three, four or more slotted TDMA channels. For simplicity, a two-slot TDMA channel is shown and described. The TDMA structure utilizes a measure of information to be condensed into a smaller packet of information for transmission. For example, sixty (60) milliseconds of audio can be condensed into a thirty (30) millisecond burst of information on the inbound channel. A communication device 120, however, that receives the 30 millisecond burst of information receives the full 60 millisecond of audio. This technology is well known in the art and is not described in greater detail in the present disclosure.

After transmitting the burst of information at step 210, the communication device 110 switches to slot B of the two-slot TDMA channel, scans slot B, and reads signaling information embedded in a second transmission being transmitted in slot B at step 220. In practice, for example, the communication device 110 transmits a burst of information in slot A (the communication device 110 condenses 60 milliseconds of audio into a 30 millisecond burst) and utilizes the gap in time between transmission of bursts to scan the alternate channel, slot B, for critical transmissions (during the remaining 30 milliseconds, the communication device switches to the alternate slot, slot B, scans for critical transmissions, and then switches back to its own transmission in slot A).

When scanning for critical transmissions, the communication device 110 reads signaling information segments embedded within the bursts of the second transmission being transmitted in slot B; at least a portion of the signaling information segments embedded in the second transmission is required to assemble an entire embedded link control message. The communication device 110 determines if all the embedded signaling information segments that is required to assemble the embedded link control message have been read from the second transmission at step 230. If the communication device 110 has not read all the embedded signaling information segments from the second transmission that is required to assemble the embedded link control message, the communication device 110 switches back to slot A at step 240, and transmits another burst of information from the first transmission (i.e., its own transmission) in slot A. This loop continues until the communication device 110 has read all of the embedded signaling information segments required to assemble an entire embedded link control message from the second transmission.

When the communication device 100 has read all of the embedded signaling information segments from the second transmission that is required to assemble the embedded link control message at step 230, the communication device 100 determines whether the second transmission is considered a critical transmission at step 250. If the second transmission being transmitted in slot B is not a critical transmission (e.g., low priority, a lower priority than the first transmission, or non-emergency), the communication device 100 continues with its own transmission by switching back to slot A at step 240, and transmitting another burst of information from the first transmission (i.e., its own transmission) in slot A. If, however, the second transmission being transmitted in slot B is critical (e.g., high priority, a higher priority than the first transmission or emergency), the communication device 100 independently determines whether it should terminate the first transmission (i.e., its own transmission) being transmitted in slot A at step 260. If the communication device 100 does not decide to terminate the first transmission at step 260, the communication device 100 switches back to slot A at step 240, and transmits another burst of information from the first transmission (i.e., its own transmission) in slot A. If, however, the communication device 110 independently decides to terminate the first transmission at step 260, the communication device 100 remains on slot B and receives the second transmission being transmitted in slot B at step 270. Thus, the present disclosure enables the communication device 100 to detect critical transmissions in progress by other communication devices and respond quickly, if necessary.

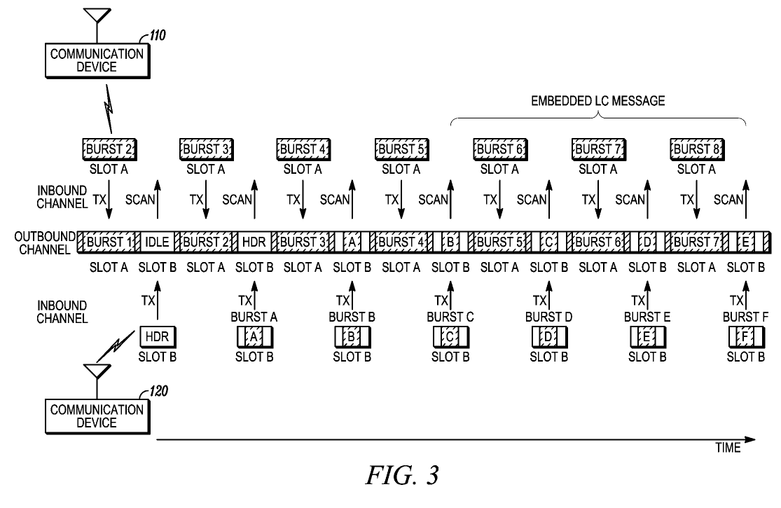

Let us now describe the present disclosure pictorially with reference to FIG. 3. FIG. 3 illustrates an embodiment of a two-slot TDMA channel having a slot A and a slot B. The TDMA channel is used by communication device 110 and communication device 120. The TDMA channel has an inbound channel and an outbound channel, each of which is divided into slots. The inbound channel is represented by directional arrows from communication device 110 and communication device 120 to the outbound channel. Communication device 110 transmits bursts in slot A and communication device 120 transmits bursts in slot B. “Burst” in FIG. 2 refers to portions of an audio, a video, a control, and/or a data transmission, as mentioned above.

The outbound channel illustrates the outbound transmissions occurring on the two-slot TDMA outbound channel. Slot A and slot B are separated in time and each slot is capable of carrying an independent transmission. As communication device 110 and communication device 120 transmit bursts on their respective inbound channels, the bursts are repeated in the outbound channel. Each burst is repeated on the outbound channel, for example in a present embodiment, approximately sixty (60) milliseconds, after the initial transmission. For example, communication device 110 transmits Burst 2 to the base station 140 on its inbound channel. Burst 2 is repeated later in time on the outbound channel. Similarly, communication device 120 transmits a header burst to the base station 140, and the header burst is repeated in the outbound channel. Various signal transmission speeds and configurations are also contemplated.

Communication device 110 is able to receive from both slots of the TDMA channel when it is not transmitting. While transmitting, communication device 110 is able to detect at least a portion of the burst being transmitted in the alternate slot, slot B. Likewise, communication device 120 is able to receive on both channels, and while transmitting, it is able to detect at least a portion of the burst being transmitted in the alternate slot, slot A. For simplicity, the present embodiment refers to the point of view of communication device 110; however, it is important to note that each communication device is capable of scanning the alternate slot.

A first transmission being transmitted in slot A, and a second transmission being transmitted in slot B is shown in FIG. 2. As noted above, either transmission may be audio, video, control, or data transmission. The transmission being transmitted by communication device 120 in slot B comprises at least the following bursts: Burst A, Burst B, Burst C, Burst D, Burst E and Burst F. One (1) burst contains an embedded synchronization pattern while the remaining bursts contain embedded signaling information, indicated by a, b, c, d, e, and f. In this particular example, of these bursts containing embedded signaling information, four (4) bursts contain embedded signaling information segments (i.e., b, c, d, and e) that together form the embedded link control message, Embedded LC. The embedded signaling information segments are positioned within the bursts in slot B such that the communication device 110 has sufficient time to transition from its own transmission in slot A to read at least one of the embedded signaling information segments in slot B, and back to slot A, without disrupting its own transmission in slot A.

The embedded link control message contains information regarding the origin, destination, transmission type and relative importance of the transmission. The relative importance of the transmission may be indicated, for example, by a service options field found embedded within at least one of the embedded signaling information segments. In the present embodiment, the service options field is an eight-bit field having one of the bits indicating whether the transmission is an emergency or not and a set of bits indicating the relative priority of the transmission. Communication device 110 determines if the transmission in slot B is more critical than its own transmission in slot A by comparing the emergency and priority bits to its own. It is contemplated, however, that other methods indicating the relative importance of a transmission may also be compatible with the present disclosure.

The embedded signaling information segments is positioned within the bursts to allow time for communication device 110 to transition to the outbound channel of slot B, read the embedded signaling information segment or embedded synchronization information, and transition back to slot A to continue transmitting its own transmission without interruption. Positioning the embedded signaling information segment in this manner allows the communication device to quickly respond to critical transmissions. In order to allow the communication device 110 to continuously transition between transmitting in slot A and scanning slot B, the communication device 110 synchronizes its timing to the outbound channel timing.

Further, the embedded link control message allows the communication device 110 to have all the necessary information required, including the relative criticality of the transmission, to independently determine if it will terminate its own transmission and receive the transmission being transmitted in the alternate slot or if it will continue with its own transmission in slot A. It is important to note that, unlike reverse channel messaging in which the communication device 110 is sent a specific message from another communication device or base station 140 to halt its transmission, in the present disclosure, communication device 110 is monitoring normal activity being transmitted in slot B of the same frequency pair while transmitting in its own transmission in slot A. The signaling information segments embedded in a transmission being transmitted in slot B do not instruct the communication device 110 to terminate its own transmission being transmitted in slot A. Rather, the communication device 110 continuously scans the transmission being transmitted in slot B for embedded signaling information segments, and independently determines whether to terminate its own transmission and receive the second transmission being transmitted in slot B, or whether to continue transmitting its own transmission in slot A.

In conclusion, the present disclosure allows a communication device operating in a half-duplex mode to periodically scan for critical transmissions in an alternate slot of a conventional TDMA channel while transmitting in its own slot on the channel without interruption. Thus, the present disclosure allows a communication device to transmit its own transmission, as well as be aware of critical transmissions being transmitted in the alternate slot.

While the present invention is susceptible of embodiment in various forms, there is shown in the drawings and is described a presently preferred embodiment with the understanding that the present disclosure is to be considered an exemplification of the invention and is not intended to limit the invention to the specific embodiment illustrated. In addition, in the present disclosure, the words “a” or “an” are to be taken to include both the singular and the plural. Conversely, any reference to plural items shall, where appropriate, include the singular.

It should be further understood that the title of this section of this specification, namely, “Detailed Description of the Disclosure”, relates to a requirement of the United States Patent Office, and does not imply, nor should be inferred to limit the subject matter disclosed herein.

All patents referred to herein, are incorporated herein by reference, whether or not specifically done so within the text of this disclosure.

Further advantages and modifications of the above described method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for scanning for critical transmissions while transmitting on a convention time division multiple access (TDMA) channel in a wireless communication system, the TDMA channel having a plurality of slots, the method comprising the steps of, at a communication device:
transmitting at least one burst of information from a first transmission in a first slot;
switching to a second slot;
reading at least one signaling information segment embedded in a second transmission that is being transmitted in the second slot; and
determining whether to terminate the first transmission in order to receive the second transmission, or to switch back to the first slot and repeat the steps of transmitting, switching, reading and determining.

2. The method in accordance with claim 1, wherein the communication device performs the step of determining without receiving instructions from another device in the wireless communication system.

3. The method in accordance with claim 1, further comprising the step of determining that the signaling information segments embedded in the second transmission that are needed to assemble a link control message have been read prior to determining to terminate the first transmission in order to receive the second transmission.

4. The method in accordance with claim 3, further comprising the step of determining whether the second transmission is a critical transmission based on the link control message, and wherein the step of determining to switch back to the first slot and repeat the steps of transmitting, switching, reading and determining occurs if the second transmission is determined not to be a critical transmission.

5. The method in accordance with claim 4, wherein the step of determining whether the second transmission is a critical transmission comprises at least one of the following:
scanning a service options field in the link control message;
scanning an emergency bit in the link control message; or
scanning a priority bit in the link control message.

6. The method in accordance with claim 3, further comprising the step of determining whether the second transmission is a critical transmission based on the link control message, and wherein the step of determining to terminate the first transmission in order to receive the second transmission occurs if the second transmission is a critical transmission.

7. The method in accordance with claim 6, wherein the step of determining whether the second transmission is a critical transmission comprises at least one of the following:
scanning a service options field in the link control message;
scanning an emergency bit in the link control message; or
scanning a priority bit in the link control message.

8. The method in accordance with claim 1, further comprising the step of determining whether the second transmission is a critical transmission by comparing a priority value of the second transmission with a priority value of the first transmission, and wherein the step of determining to terminate the first transmission in order to receive the second transmission, or to switch back to the first slot and repeat the steps of transmitting, switching, reading and determining is based on whether the second transmission is determined to be a critical transmission.

9. The method in accordance with claim 1, wherein the first transmission and the second transmission comprise at least one of: audio information, video information, control information, or data information.

10. The method in accordance with claim 1, wherein the steps of switching to the second slot, and reading at least one signaling information segment embedded in the second transmission that is being transmitted in the second slot do not interfere with transmitting the first transmission in the first slot.

11. The method in accordance with claim 1, wherein the step of determining to switch back to the first slot and repeat the steps of transmitting, switching, reading and determining occurs if the signaling information segments embedded in the second transmission that is needed to assemble a link control message has not been read.

12. The method in accordance with claim 1, wherein the communication device operates in a half-duplex mode.

13. A method for scanning for critical transmissions while transmitting on a convention time division multiple access (TDMA) channel in a wireless communication system, the TDMA channel having a plurality of slots, the method comprising the steps of, at a communication device:
transmitting at least one burst of information from a first transmission in a first slot;
switching to a second slot;
reading at least one signaling information segment embedded in a second transmission that is being transmitted in the second slot;
switching back to the first slot and repeating the steps of transmitting, switching, reading, and switching back until the signaling information segments embedded in the second transmission that is needed to assemble a link control message has been read; and
upon reading the signaling information segments embedded in the second transmission that is needed to assemble the link control message, determining whether to terminate transmission of the first transmission in order to receive the second transmission, or switch back to the first slot and repeat the steps of transmitting, switching, reading, and switching back.

14. The method in accordance with claim 13, wherein the communication device performs the step of determining without receiving instructions from a device in the wireless communication system.

15. The method in accordance with claim 13, further comprising the step of determining whether the second transmission is a critical transmission by comparing a priority value of the second transmission with a priority value of the first transmission, and wherein the step of determining to terminate the first transmission in order to receive the second transmission, or to switch back to the first slot and repeat the steps of transmitting, switching, reading and switching back is based on whether the second transmission is determined to be a critical transmission.

16. A communication device used for scanning for critical transmissions while transmitting on a convention time division multiple access (TDMA) channel in a wireless communication system, the TDMA channel having a plurality of slots, the communication device comprising at least a processor, and a transmitter coupled to the processor, wherein the processor selectively performs the following functions:
instructing the transmitter to transmit at least one burst of information from a first transmission in a first slot;
switching to a second slot;
reading at least one signaling information segment embedded in a second transmission that is being transmitted in the second slot; and
determining whether to terminate the first transmission in order to receive the second transmission, or to switch back to the first slot and repeat the steps of instructing, switching, reading and determining.

17. The communication device in accordance with claim 16, wherein the processor selectively performs the step of determining without receiving instructions from another device in the wireless communication system.

18. The communication device in accordance with claim 16, wherein the processor selectively performs the further step of determining that the signaling information segments embedded in the second transmission that are needed to assemble a link control message have been read prior to determining to terminate the first transmission in order to receive the second transmission.

19. The communication device in accordance with claim 16, wherein the processor selectively performs the further step of determining whether the second transmission is a critical transmission by comparing a priority value of the second transmission with a priority value of the first transmission, and wherein the step of determining to terminate the first transmission in order to receive the second transmission, or to switch back to the first slot and repeat the steps of transmitting, switching, reading and determining is based on whether the second transmission is determined to be a critical transmission.

20. The communication device in accordance with claim 16, wherein the first transmission and the second transmission comprise at least one of: audio information, video information, control information, or data information.
